(19) United States
(12) Patent Application Publication
(10) Pub. No.: US 2024/0005897 A1
(43) Pub. Date: Jan. 4, 2024

(54) SOUND EDITING DEVICE, SOUND EDITING METHOD, AND SOUND EDITING PROGRAM

(71) Applicant: Yamaha Corporation, Hamamatsu (JP)

(72) Inventors: Kouhei SUMI, Hamamatsu (JP); Takahiro ASANO, Hamamatsu (JP); Ikumi OSAKI, Hamamatsu (JP)

(21) Appl. No.: 18/468,525

(22) Filed: Sep. 15, 2023

Related U.S. Application Data
(63) Continuation of application No. PCT/JP2022/010400, filed on Mar. 9, 2022.

(30) Foreign Application Priority Data
Mar. 24, 2021 (JP) 2021-050384

(51) Int. Cl. G10H 1/00

(52) U.S. Cl. CPC G10H 1/0091; G10H 1/0008; G10H 2250/311

(57) ABSTRACT

A sound editing device includes at least one processor that is configured to execute a first receiving unit configured to receive a first audio signal, a second receiving unit configured to receive a second audio signal, and an estimation unit configured to estimate effect information that reflects an effect to be applied to the first audio signal, from the first and second audio signals, by using a trained model indicating an input-output relationship between first and second input audio signals and output effect information that reflects an effect to be applied to the first input audio signal.

### CROSS-REFERENCE TO RELATED APPLICATIONS

This application is a continuation application of International Application No. PCT/JP2022/010400, filed on Mar. 9, 2022, which claims priority to Japanese Patent Application No. 2021-050384 filed in Japan on Mar. 24, 2021. The entire disclosures of International Application No. PCT/JP2022/010400 and Japanese Patent Application No. 2021-050384 are hereby incorporated herein by reference.

### BACKGROUND

### Technological Field

This disclosure relates to a sound editing device, a sound editing method, and a sound editing program for editing sound.

### Background Information

In an ensemble, a plurality of performers play musical instruments simultaneously. Therefore, it is preferred that each performer adjust their own volume, so that a balanced volume among the instruments played by the surrounding performers is maintained. However, a performer tends to increase his/her own volume because it is difficult for the performer to hear his/her own volume. In this case, because the other performers also tend to increase their own volume, it is difficult to maintain a balanced volume. Particularly if the performance hall is small, the sound will saturate and circulate within the hall, making it more difficult to maintain the balanced volume.

### SUMMARY

It is thought that by adding effects to the audio signal to increase clarity of sound, the performer will be able to recognize his/her own output sound without increasing the volume of the musical instrument. For example, Japanese Laid Open Patent Application No. 2020-160139 discloses an effect addition device that adds various sound effects to an audio signal. However, because the clarity of each performer's sound changes in accordance with the sounds of the surrounding performers, the addition of effects to an audio signal to increase clarity of sound is not a simple matter.

An object of this disclosure is to provide a sound editing device, a sound editing method, and a sound editing program that can easily increase clarity of sound.

A sound editing device according to one aspect of this disclosure comprises at least one processor configured to execute a first receiving unit configured to receive a first audio signal, a second receiving unit configured to receive a second audio signal, and an estimation unit configured to estimate effect information that reflects the effect to be applied to the first audio signal from the first audio signal and the second audio signal, by using a trained model indicating an input-output relationship between first and second input audio signals and output effect information that reflects the effect to be applied to the first input audio signal.

A sound editing method according to another aspect of this disclosure comprises receiving a first audio signal, receiving a second audio signal, and estimating effect information that reflects an effect to be applied to the first audio signal from the first audio signal and the second audio signal, by using a trained model indicating an input-output relationship between first and second input audio signals and output effect information that reflects an effect to be applied to the first input audio signal. The sound editing method is executed by a computer.

A non-transitory computer-readable medium storing a sound editing program according to yet another aspect of this disclosure causes a computer to execute a sound editing method comprising receiving a first audio signal, receiving a second audio signal, and estimating effect information that reflects an effect to be applied to the first audio signal from the first audio signal and the second audio signal, by using a trained model indicating an input-output relationship between first and second input audio signals, and output effect information that reflects an effect to be applied to the first input audio signal.

### BRIEF DESCRIPTION OF THE DRAWINGS

FIG. 1 is a block diagram showing the configuration of a processing system that includes a sound editing device according to a first embodiment of this disclosure.

FIG. 2 is a block diagram showing the configuration of the sound learning device and the sound editing device of FIG. 1.

FIG. 3 is a diagram showing an example of a first audio signal and a third audio signal.

FIG. 4 is a flowchart showing an example of the sound learning process by the sound learning device of FIG. 2.

FIG. 5 is a flowchart showing an example of the sound editing process by the sound editing device of FIG. 2.

FIG. 6 is a block diagram showing the configuration of a processing system that includes a sound editing device according to a second embodiment of this disclosure.

FIG. 7 is a block diagram showing the configuration of the sound learning device and the sound editing device of FIG. 6.

FIG. 8 is a flowchart showing an example of the sound learning process by the sound learning device of FIG. 7.

FIG. 9 is a flowchart showing an example of the sound editing process by the sound editing device of FIG. 7.

FIG. 10 is a block diagram showing the configuration of the sound editing device according to another embodiment.

### DETAILED DESCRIPTION OF THE EMBODIMENTS

Selected embodiments will now be explained with reference to the drawings. It will be apparent to those skilled in the field from this disclosure that the following descriptions of the embodiments are provided for illustration only and not for the purpose of limiting the invention as defined by the appended claims and their equivalents.

### 1. First Embodiment

### (1) Configuration of the Processing System

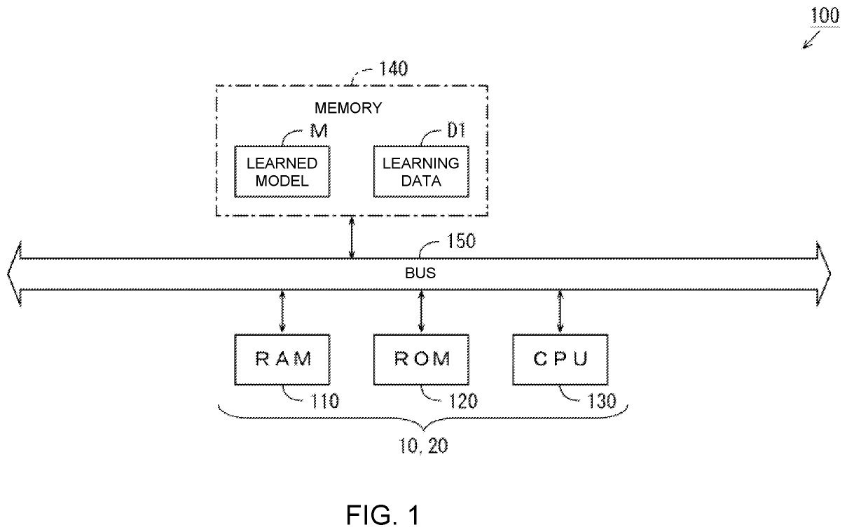

The sound editing device, the sound editing method, and the sound editing program according to an embodiment of this disclosure will be described in detail below with reference to the drawings. FIG. 1 is a block diagram showing the configuration of a processing system that includes the sound editing device according to the first embodiment of this disclosure. As shown in FIG. 1, a processing system 100 includes RAM (random-access memory) 110, ROM (read-only memory) 120, CPU (central processing unit) 130, and a memory (storage unit) 140.

The processing system 100 is provided in an effector or a speaker, for example. In addition, the processing system 100 can be realized by an information processing device such as a personal computer, for example, or by an electronic instrument equipped with a performance function. The RAM 110, the ROM 120, the CPU 130, and the memory 140 are connected to a bus 150. The RAM 110, the ROM 120, and the CPU 130 constitute a sound learning device 10 and a sound editing device 20. In the present embodiment, the sound learning device 10 and the sound editing device 20 are configured by the common processing system 100, but can be configured by separate processing systems.

The RAM 110 is a volatile memory, for example, and is used as a work area for the CPU 130, temporarily storing various data. The ROM 120 is a non-volatile memory, for example, and stores a sound learning program and a sound editing program. The CPU 130 is one example of at least one processor as an electronic controller of the processing system 100. The CPU 130 executes the sound learning program stored in the ROM 120 on the RAM 110 to perform the sound learning process. The CPU 130 executes the sound editing program stored in the ROM 120 on the RAM 110 to perform the sound editing process. Here, the term “electronic controller” as used herein refers to hardware, and does not include a human. The processing system 100 can include, instead of the CPU 130 or in addition to the CPU 130, one or more types of processors, such as a GPU (Graphics Processing Unit), a DSP (Digital Signal Processor), an FPGA (Field Programmable Gate Array), an ASIC (Application Specific Integrated Circuit), and the like. Details of the sound learning process and the sound editing process will be described below.

The sound learning program or the sound editing program can be stored in the memory 140 instead of the ROM 120. Alternatively, the sound learning program or the sound editing program can be provided in a form stored on a computer-readable storage medium and installed in the ROM 120 or the memory 140. Alternatively, if the processing system 100 is connected to a network, such as the Internet, a sound learning program or a sound editing program distributed from a server (including a cloud server.) on the network can be installed in the ROM 120 or the memory 140. The ROM 120 and the memory 140 are examples of a non-transitory computer-readable medium.

The memory (computer memory) 140 includes a storage medium such as a hard disk, an optical disk, a magnetic disk, or a memory card, and stores a trained model M and a plurality of training data D1. Trained model M or the plurality of training data D1 need not be stored in the memory 140 but can be stored in a computer-readable storage medium. Alternatively, in the case that the processing system 100 is connected to a network, trained model M or the plurality of training data D1 can be stored on a server on said network. Trained model M is constructed based on the plurality of training data D1. Details of trained model M will be described further below.

In the present embodiment, each piece of training data D1 includes multiple (multi-track) waveform data representing a first input audio signal, a second input audio signal, and an output audio signal. The first input audio signal corresponds to the sound that is assumed to be played by a first user, such as the sound played using the same type of musical instrument as that used by the first user. The second input audio signal corresponds to the sound that is assumed to be played by a second user, such as the sound played using the same type of musical instrument as that used by the second user.

The output audio signal is an example of output effect information according to the present embodiment, and is an audio signal in which an effect to be applied has been applied to the first input audio signal based on the first input audio signal and the second input audio signal. In a state in which the second input audio signal is input simultaneously, the clarity of sound corresponding to the output audio signal is greater than the clarity of sound corresponding to the first input audio signal. The waveform data representing the output audio signal can be generated from waveform data representing the first input audio signal by adjusting the parameters of the effect.

### (2) Sound Learning Device and Sound Editing Device

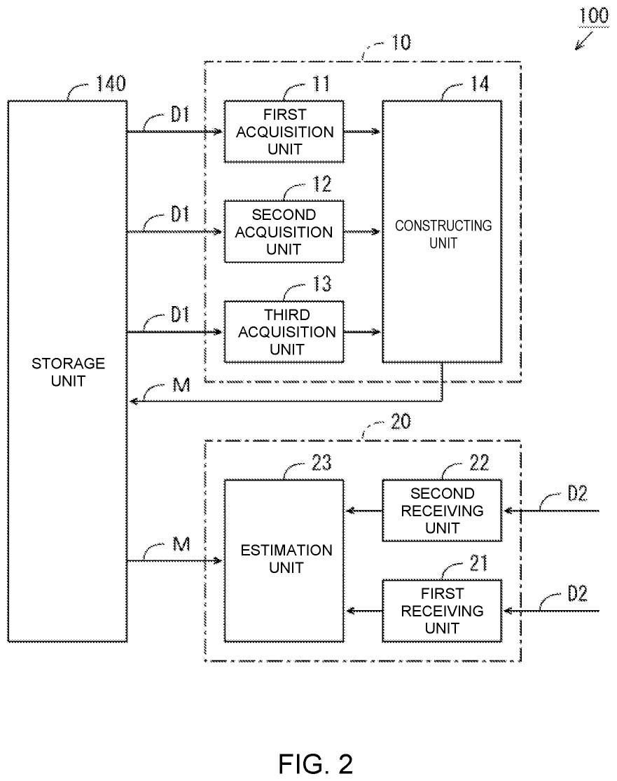

FIG. 2 is a block diagram showing the configuration of the sound learning device 10 and the sound editing device 20 of FIG. 1. As shown in FIG. 2, the sound learning device 10 includes, as functional units, a first acquisition unit 11, a second acquisition unit 12, a third acquisition unit 13, and a construction unit 14. The functional units of the sound learning device 10 are realized/executed by the CPU 130 when the CPU 130 of FIG. 1 executes the sound learning program. At least some of the functional units of the sound learning device 10 can be realized in hardware, such as electronic circuitry.

The first acquisition unit 11 acquires the first input audio signal from training data D1 stored in the memory 140, or the like. The second acquisition unit 12 acquires the second input audio signal from training data D1. The third acquisition unit 13 acquires the output audio signal from training data D1.

The construction unit 14 machine-learns the output audio signal acquired by the third acquisition unit 13 based on the first input audio signal and the second input audio signal respectively acquired by the first acquisition unit 11 and the second acquisition unit 12, for training data D1. By repeating the machine learning for the plurality of training data D1, the construction unit 14 constructs trained model M representing the input-output relationship between the first and second input audio signals and the output audio signal.

In the present embodiment, the construction unit 14 executes machine learning using U-Net, for example, but the embodiment is not limited in this way. The construction unit 14 can carry out machine learning using another method, such as CNN (Convolutional Neural Network) or FCN (Fully Convolutional Network). Trained model M constructed by the construction unit 14 is stored in the memory 140, for example. Trained model M constructed by the construction unit 14 can be stored in a server on a network.

The sound editing device 20 includes, as functional units, a first receiving unit 21, a second receiving unit 22, and an estimation unit 23. The functional units of the sound editing device 20 are realized/executed by the CPU 130 when the CPU 130 of FIG. 1 executes the sound editing program. At least some of the functional units of the sound editing device 20 can be realized in hardware, such as electronic circuitry.

In the present embodiment, the first receiving unit 21 and the second receiving unit 22 acquire music data D2. Music data D2 include a plurality of waveform data representing the first and second audio signals and are generated by a plurality of performers, including the user, performing in an ensemble. The first audio signal corresponds to the sounds performed by the user. The second audio signal corresponds to the sounds performed by another performer, or the sounds generated in the user's surroundings. The first receiving unit 21 receives the first audio signal from music data D2. The second receiving unit 22 receives the second audio signal from music data D2.

The estimation unit 23 estimates a third audio signal from the first and second audio signals included in music data D2 using trained model M stored in the memory 140, or the like, in which the effect to be applied has been applied to the first audio signal. The estimation unit 23 also outputs the estimated third audio signal. In the present embodiment, the third audio signal is an example of the effect information.

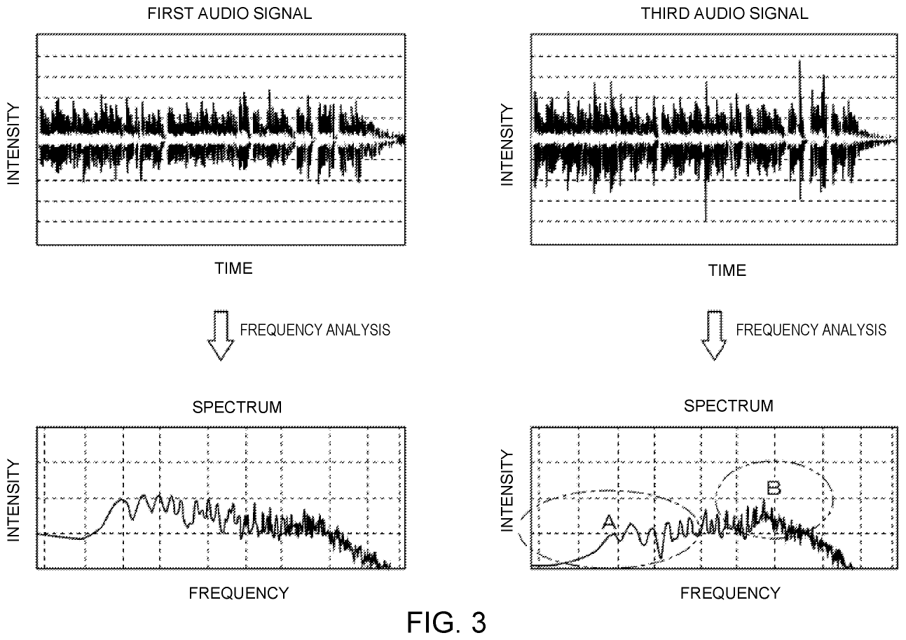

FIG. 3 is a diagram showing an example of the first audio signal and the third audio signal. The left column of FIG. 3 shows the first audio signal included in music data D2 and the spectrum obtained by frequency analysis of the first audio signal. The right column of FIG. 3 shows the third audio signal output by the estimation unit 23 and the spectrum obtained by frequency analysis of the third audio signal.

In the example of FIG. 3, as indicated by portion A surrounded by the dashed-dotted line in the band of relatively low frequency, the intensity of the third audio signal is reduced more than the intensity of the first audio signal. On the other hand, as indicated by portion B surrounded by the chain double-dashed line in the band of relatively high frequency, the intensity of the third audio signal is increased more than the intensity of the first audio signal. As a result, in situations in which the second audio signal is generated simultaneously, the clarity of sound corresponding to the third audio signal is greater than the clarity of sound corresponding to the first audio signal.

Therefore, the user can use the third audio signal output by the estimation unit 23 to easily recognize his or her own output sound without increasing the volume of the musical instrument. As a result, the user can play their own musical instrument at an appropriate volume, such that a balanced volume among the instruments of the surrounding performers is maintained. Alternatively, a mixing engineer can easily perform mixing so that a balanced volume among a plurality of musical instruments is maintained.

### (3) Sound Learning Process and Sound Editing Process

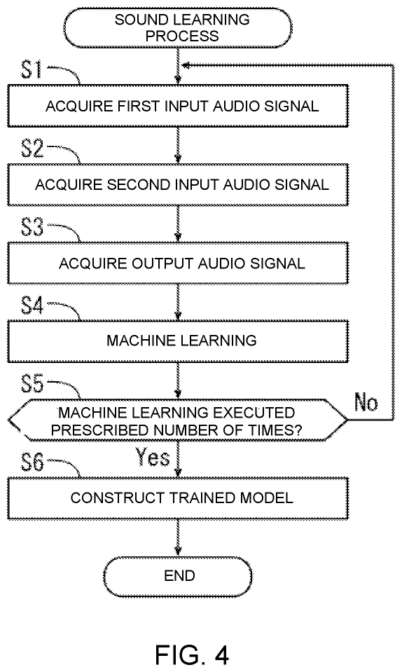

FIG. 4 is a flowchart showing an example of the sound learning process by the sound learning device 10 of FIG. 2. The sound learning process of FIG. 4 is performed by the CPU 130 of FIG. 1 executing the sound learning program.

The first acquisition unit 11 acquires the first input audio signal from training data D1 stored in the memory 140, or the like (Step S1). The second acquisition unit 12 acquires the second input audio signal from the training data D1 of Step S1 (Step S2). The third acquisition unit 13 acquires the output audio signal from the training data D1 of Step S1 (Step S3). Any of Steps S1-S3 can be executed first, or the steps can be executed simultaneously.

The construction unit 14 then machine-learns the input-output relationship between the first and second input audio signals acquired in Steps S1 and Step S2, respectively, and the output audio signal acquired in Step S3 (Step S4). The construction unit 14 then determines whether machine learning has been executed a prescribed number of times (Step S5). If machine learning has not been executed the prescribed number of times, the construction unit 14 returns to Step S1.

Steps S1-S5 are repeated as training data D1 or the learning parameters are changed until machine learning has been executed the prescribed number of times. The number of machine learning iterations is set in advance in accordance with the precision of the trained model to be constructed. If machine learning has been executed the prescribed number of times, the construction unit 14 constructs the trained model M representing the input-output relationship between the first and second input audio signals and the output audio signal, based on the result of the machine learning (Step S6), and ends the sound learning process.

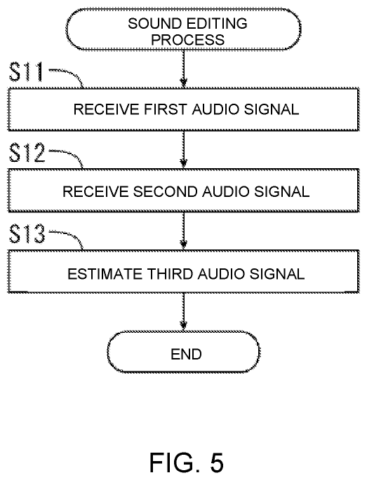

FIG. 5 is a flowchart showing an example of the sound editing process by the sound editing device 20 of FIG. 2. The sound editing process of FIG. 5 is carried out by the CPU 130 of FIG. 1 executing the sound editing program.

The first receiving unit 21 receives the first audio signal from music data D2 (Step S11). The second receiving unit 22 receives the second audio signal from music data D2 of Step S11 (Step S12). Either Step S11 or S12 can be executed first, or the steps can be executed simultaneously. The estimation unit 23, by using the trained model M constructed in Step S6 of the sound learning process, estimates the third audio signal from the first audio signal and the second audio signal respectively received in Steps S11 and S12 (Step S13) and ends the sound editing process.

### (4) Effects of the Embodiment

As described above, the sound editing device 20 according to the present embodiment comprises the first receiving unit 21 that receives the first audio signal, the second receiving unit 22 that receives the second audio signal, and the estimation unit 23 that, by using the trained model M indicating the input-output relationship between the first and second input audio signals and the output effect information, which reflects the effect to be applied to the first input audio signal, estimates, from the first and second audio signals, the effect information that reflects the effect to be applied to the first audio signal.

By this configuration, even if the second audio signal changes, the trained model M can be used to obtain the effect information that reflects the effect to be applied to the first audio signal so as to increase clarity of sound. Thus, it is possible easily to increase clarity of sound.

The effect information can include the first audio signal to which the effect to be applied has been applied (third audio signal). In this case, a sound with increased clarity can easily be obtained by using the estimated third audio signal.

Trained model M can be generated by learning of the first input audio signal to which the effect to be applied has been applied (output audio signal) as output effect information based on the first and second audio signals. In this case, trained model M can easily be generated for estimating the third audio signal from the first and second audio signals.

### 2. Second Embodiment

### (1) Configuration of a Processing System

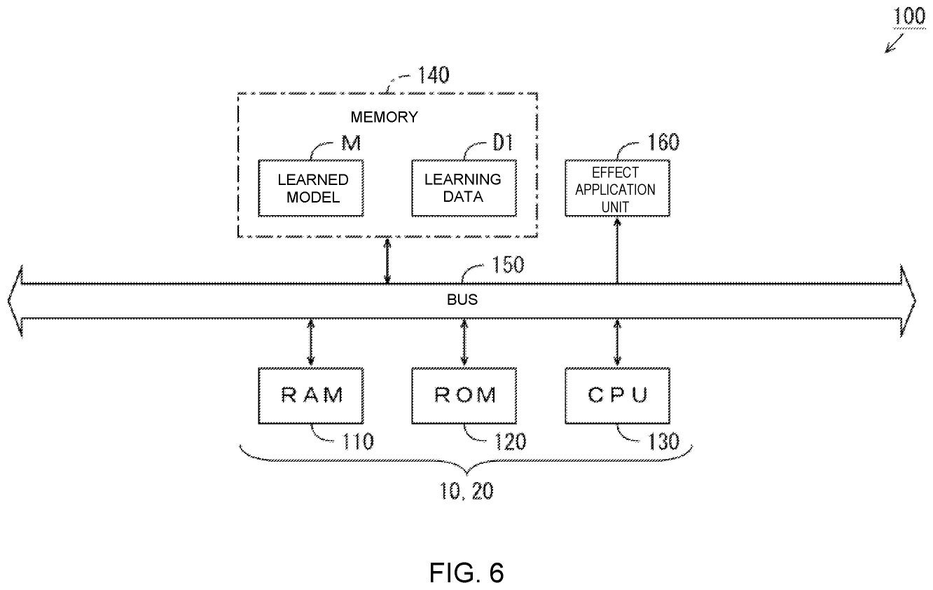

The sound editing device 20, sound editing method, and sound editing program according to the second embodiment will be described in terms of the differences from the sound editing device 20, sound editing method, and sound editing program according to the first embodiment. FIG. 6 is a block diagram showing the configuration of the processing system 100 that includes the sound editing device 20 according to the second embodiment of this disclosure. As shown in FIG. 6, the processing system 100 also comprises an effect application unit 160. The effect application unit 160 includes an equalizer or a compressor, for example, and is connected to the bus 150. The effect application unit 160 applies an effect to the audio signal based on input parameters.

In the present embodiment, the training data D1 stored in the memory 140, or the like, includes a plurality of waveform data representing the first audio signal and the second audio signal. In addition, the training data D1 includes parameters (hereinafter referred to as output parameters) that reflect the effect to be applied to the first input audio signal in order to generate the output audio signal, instead of the waveform data representing the output audio signal. The output parameter is an example of output effect information in the present embodiment.

### (2) Sound Learning Device and Sound Editing Device

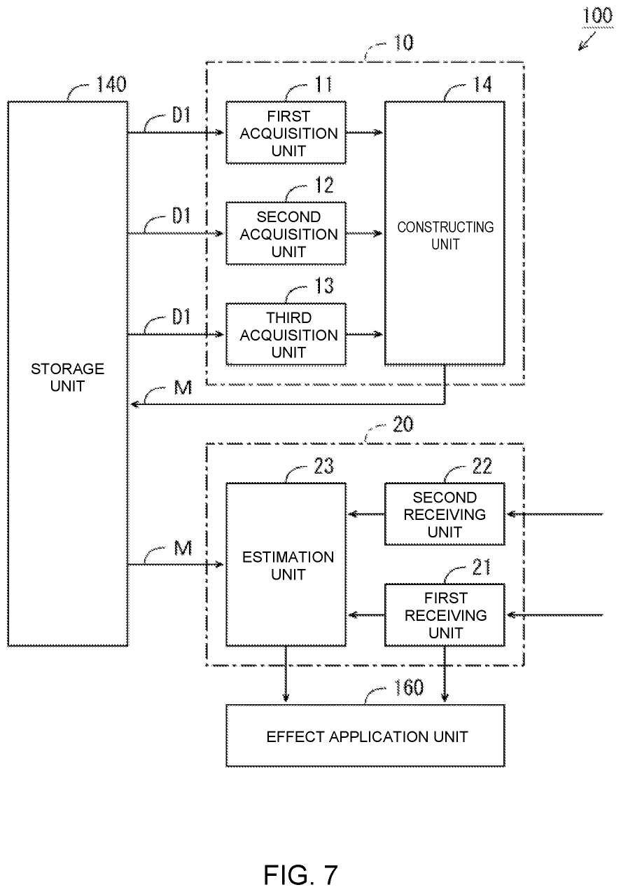

FIG. 7 shows a block diagram of the configuration of the sound learning device 10 and the sound editing device 20 of FIG. 6. In the present embodiment, the third acquisition unit 13 of the sound learning device 10 acquires the output parameters from training data D1. The operations of the first acquisition unit 11 and the second acquisition unit 12 are respectively the same as the operations of the first acquisition unit 11 and the second acquisition unit 12 in the first embodiment.

The construction unit 14 machine-learns the output parameters acquired by the third acquisition unit 13 based on the first input audio signal and the second input audio signal respectively acquired by the first acquisition unit 11 and the second acquisition unit 12 for training data D1. By repeating machine learning for the plurality of training data D1, the construction unit 14 constructs trained model M representing the input-output relationship between the first and second input audio signals and the output parameters.

In the present embodiment, the construction unit 14 executes machine learning using CNN, for example, but the embodiment is not limited in this way. The construction unit 14 can carry out machine learning using another method, such as RNN (Recurrent Neural Network), Attention, etc. Trained model M constructed by the construction unit 14 is stored in the memory 140, for example. Trained model M constructed by the construction unit 14 can be stored on a server or the like on a network.

In the sound editing device 20, the first receiving unit 21 and the second receiving unit 22 respectively acquire the first audio signal and the second audio signal generated by the ensemble in real time. The estimation unit 23 uses trained model M stored in the memory 140 or the like, and sequentially estimates, from the first and second audio signals, the parameters for generating the first audio signal to which the effect to be applied has been applied. The estimation unit 23 also sequentially outputs the parameters that have been estimated. In the present embodiment, the parameters are an example of the effect information.

The effect application unit 160 applies an effect to the first audio signal acquired by the first receiving unit 21 based on the parameters output by the estimation unit 23. As a result, a fourth audio signal similar to the third audio signal shown in the right column of FIG. 3 is generated. Therefore, in a situation in which the second audio signal is generated simultaneously, the clarity of sound corresponding to the fourth audio signal becomes greater than the clarity of sound corresponding to the first audio signal.

### (3) Sound Learning Process and Sound Editing Process

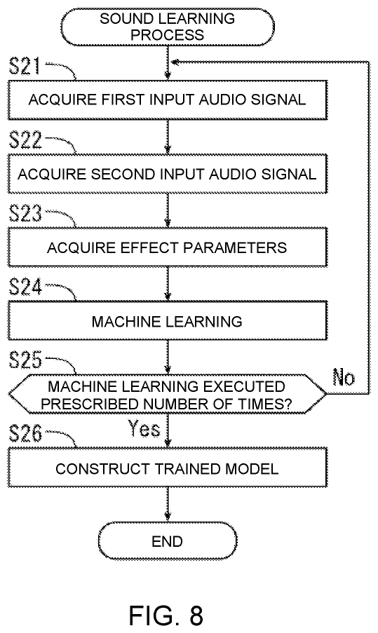

FIG. 8 is a flowchart showing an example of the sound learning process by the sound learning device 10 of FIG. 7. In the example of FIG. 8, the sound learning process includes Steps S21-S26. Steps S21 and S22 are respectively the same as the Steps S1 and S2 of the sound learning process of FIG. 4. In Step S23, the third acquisition unit 13 acquires the output parameters from the training data D1 (Step S23). Any of Steps S21-S23 can be executed first, or the steps can be executed simultaneously.

The construction unit 14 machine-learns the input-output relationship between the first input audio signal acquired in Step S21 and the second input audio signal acquired in Step S22, on the one hand, and the output parameters acquired in Step S23 (Step S24), on the other. Steps S25 and S26 are respectively the same as the Steps S5 and S6 of the sound learning process of FIG. 4. As a result, in Step S26, trained model M representing the input-output relationship between the first and second input audio signals and the output parameters is constructed.

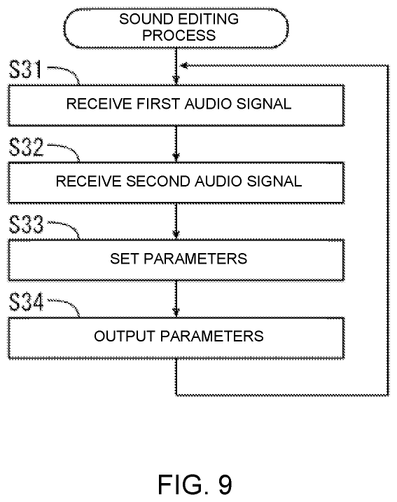

FIG. 9 is a flowchart showing an example of a sound editing process by the sound editing device 20 of FIG. 7. The first receiving unit 21 receives the first audio signal generated by the ensemble (Step S31). The second receiving unit 22 receives the second audio signal generated by the ensemble (Step S32). Steps S31 and S32 are executed essentially simultaneously.

The estimation unit 23 uses trained model M constructed in Step S26 of the sound learning process to estimate the parameters from the first audio signal and the second audio signal respectively received in Steps S31 and S32 (Step S33). Thereafter, the estimation unit 23 outputs the parameters estimated in Step S33 to the effect application unit 160 of FIG. 7 (Step S34) and returns to Step S31. Steps S31-S34 are repeated until the ensemble is finished.

### (4) Effects of the Embodiment

In the present embodiment, even if the second audio signal changes, it is possible to use trained model M to obtain the effect information that reflects the effect to be applied to the first audio signal so as to increase clarity of sound, in the same manner as in the first embodiment. Thus, clarity of sound can be easily increased.

The effect information can include parameters for generating the first audio signal to which the effect to be applied has been applied. In this case, the effect information can be obtained at high speed. Moreover, by using the fourth audio signal in which parameters have been applied to the first audio signal based on the effect information, sound with increased clarity can easily be obtained.

Trained model M can be generated by being trained to recognize output parameters for generating the first input audio signal to which the effect to be applied has been applied as output effect information based on the first audio signal and the second audio signal. In this case, trained model M for estimating the parameters from the first audio signal and the second audio signal can easily be generated.

### 3. Other Embodiments

(1) In the first embodiment, trained model M, representing the input-output relationship between the first and second input audio signals and the output audio signal, is constructed by the sound learning device 10, but no limitation is imposed thereby. In the same manner as in the second embodiment, trained model M, representing the input-output relationship between the first and second input audio signals and the output parameters, can be constructed by the sound learning device 10.

In this case, the parameters for generating the first audio signal to which the effect to be applied has been applied can be estimated by the sound editing device 20 from the first audio signal and the second audio signal, using the constructed trained model M. In this configuration, the processing speed of the CPU 130 for realizing the sound learning device 10 or the sound editing device 20 can be relatively low. The processing system 100 can also include the effect application unit 160. The parameters estimated by the sound editing device 20 are output to the effect application unit 160 to generate the fourth audio signal.

(2) In the second embodiment, trained model M, representing the input-output relationship between the first and second input audio signals and the output parameters, is constructed by the sound learning device 10, but no limitation is imposed thereby. In the same manner as in the first embodiment, trained model M, representing the input-output relationship between the first and second input audio signals and the output audio signal, can be constructed by the sound learning device 10.

In this case, the third audio signal in which the effect to be applied has been applied to the first audio signal is estimated by the sound editing device 20 from the first and second audio signals using the constructed trained model M. Therefore, the processing system 100 need not include the effect application unit 160. In this configuration, the processing speed of the CPU 130 for realizing the sound learning device 10 or the sound editing device 20 is preferably relatively high.

(3) In the embodiment described above, the effect information is estimated from the first and second audio signals using trained model M, but no limitation is imposed thereby. In the case that correspondence information, such as a table indicating the correspondence relationship between the first and second audio signals and the effect information is stored in the memory 140 or the like, the effect information can be estimated from the first and second audio signals using said correspondence information.

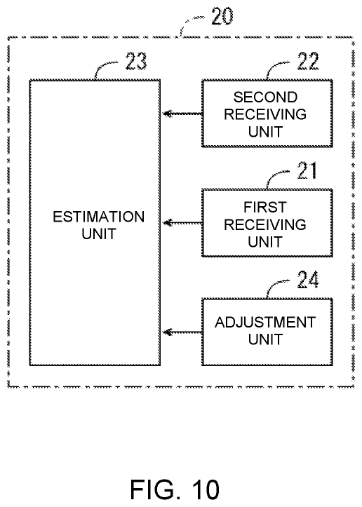

(4) FIG. 10 shows a block diagram of the configuration of the sound editing device 20 according to another embodiment. As shown in FIG. 10, the sound editing device 20 according to this other embodiment also includes an adjustment unit 24 as a functional part. The adjustment unit 24 is a user operable input (user operable adjustment input) and, for example, a GUI (Graphic User Interface) displayed on a display device, not shown, that is operated by the user. The adjustment unit 24 can be a physical dial, switch, or button, instead of the GUI. The term “user operable input” as used herein does not include a human.

If the user wishes to increase the clarity of sound even at the expense of musicality, the user can operate the adjustment unit 24 so as to increase the degree of the effect. On the other hand, if the user wishes to relax, etc., he or she can operate the adjustment unit 24 so as to decrease the degree of the effect. The adjustment unit 24 adjusts the degree of the effect to be applied to the first audio signal based on an operation from the user. The estimation unit 23 estimates the effect information that reflects the effect to be applied to the first audio signal at the degree adjusted by the adjustment unit 24 based on trained model M.

In this configuration, a plurality of training data D1 are prepared corresponding to the degree of the effect. Also, the construction unit 14 of the sound learning device 10 generates a plurality of trained models M corresponding to the degree of the effect to be applied to the first input audio signal.

### Effects

This disclosure makes it possible easily to increase clarity of sound.

What is claimed is:

1. A sound editing device comprising:
at least one processor configured to execute
a first receiving unit configured to receive a first audio signal,
a second receiving unit configured to receive a second audio signal, and
an estimation unit configured to estimate effect information that reflects an effect to be applied to the first audio signal, from the first and second audio signals, by using a trained model indicating an input-output relationship between first and second input audio signals and output effect information that reflects an effect to be applied to the first input audio signal.

2. The sound editing device according to claim 1, wherein
the effect information includes parameters for generating the first audio signal to which the effect to be applied has been applied.

3. The sound editing device according to claim 2, wherein
the trained model is generated by learning of output parameters as the output effect information based on the first and second input audio signals, and the output parameters are parameters for generating the first input audio signal to which the effect to be applied has been applied.

4. The sound editing device according to claim 1, wherein
the effect information includes the first audio signal to which the effect to be applied has been applied.

5. The sound editing device according to claim 4, wherein
the trained model is generated by learning of the first input audio signal to which the effect to be applied has been applied as the output effect information, based on the first and second input audio signals.

6. The sound editing device according to claim 1, further comprising
a user operable adjustment input configured to adjust a degree of the effect to be applied to the first audio signal, wherein
the estimation unit is configured to estimate the effect information that reflects the effect to be applied to the first audio signal at the degree, by using the trained model.

7. The sound editing device according to claim 6, wherein
a plurality of trained models including the trained model, which correspond to degrees of the effect to be applied to the first input audio signal, are generated.

8. A sound editing method executed by a computer, the sound editing method comprising:
receiving a first audio signal;
receiving a second audio signal; and
estimating effect information that reflects an effect to be applied to the first audio signal, from the first and second audio signals, by using a trained model indicating an input-output relationship between first and second input audio signals and output effect information that reflects an effect to be applied to the first input audio signal.

9. The sound editing method according to claim 8, wherein
the effect information includes parameters for generating the first audio signal to which the effect to be applied has been applied.

10. The sound editing method according to claim 9, wherein
the trained model is generated by learning of output parameters as the output effect information based on the first and second input audio signals, and the output parameters are parameters for generating the first input audio signal to which the effect to be applied has been applied.

11. The sound editing method according to claim 8, wherein
the effect information includes the first audio signal to which the effect to be applied has been applied.

12. The sound editing method according to claim 11, wherein
the trained model is generated by learning of the first input audio signal to which the effect to be applied has been applied as the output effect information, based on the first and second input audio signals.

13. The sound editing method according to claim 8, further comprising
adjusting a degree of the effect to be applied to the first audio signal, and
the estimating of the effect information is performed by estimating the effect information that reflects the effect to be applied to the first audio signal at the degree, based on the trained model.

14. The sound editing method according to claim 13, wherein
a plurality of trained models including the trained model, which correspond to degrees of the effect to be applied to the first input audio signal, are generated.

15. A non-transitory computer-readable medium storing a sound editing program that causes a computer to execute a sound editing method, the sound editing method comprising:
receiving a first audio signal;
receiving a second audio signal; and
estimating effect information that reflects an effect to be applied to the first audio signal, from the first and second audio signals, by using a trained model indicating an input-output relationship between first and second input audio signals and output effect information that reflects an effect to be applied to the first input audio signal.

16. The non-transitory computer-readable medium according to claim 15, wherein
the effect information includes parameters for generating the first audio signal to which the effect to be applied has been applied.

17. The non-transitory computer-readable medium according to claim 16, wherein
the trained model is generated by learning of output parameters as the output effect information based on the first and second input audio signals, and the output parameters are parameters for generating the first input audio signal to which the effect to be applied has been applied.

18. The non-transitory computer-readable medium according to claim 15, wherein
the effect information includes the first audio signal to which the effect to be applied has been applied.

19. The non-transitory computer-readable medium according to claim 18, wherein
the trained model is generated by learning of the first input audio signal to which the effect to be applied has been applied as the output effect information, based on the first and second input audio signals.

20. The non-transitory computer-readable medium according to claim 15, wherein
the sound editing method further comprises adjusting a degree of the effect to be applied to the first audio signal, and
the estimating of the effect information is performed by estimating the effect information that reflects the effect to be applied to the first audio signal at the degree, based on the trained model.
